(19) United States
(12) Patent Application Publication
(10) Pub. No.: US 2008/0271579 A1
(43) Pub. Date: Nov. 6, 2008

(54) Electronic hand tool with at least one button having inclined upper surface

(76) Inventor: Chih-Ching Hsieh, Taichung City (TW)

Correspondence Address: Chih-Ching Hsieh, 235 Chung-Ho, Box 8-24, Taipei, TW

(21) Appl. No.: 11/799,486

(22) Filed: May 2, 2007

(51) Int. Cl. B25B 23/142

(52) U.S. Cl. 81/467

(57) ABSTRACT

An electronic hand tool comprises a handle installed with an electronic device for deriving a tension of the tool as the tool is used to drive an object and displaying the derived tension value; the handle being installed with an operating portion; the operating portion including a button which slightly protrudes from a surface of the handle; and an upper surface of the button being an inclined surface. The button has at least one function of controlling the actuation the electronic device, calibration of the tension value, and adjusting the range of the tension, and determining the displaying unit of the tension value. The inclined surface may be a cambered concave surface. One end of the driving portion is a ratchet head and another end of the driving portion is an opened end; and the ratchet head and opened end are installed at two ends of the handle.

### FIELD OF THE INVENTION

The present invention relates to hand tools, and particularly to an electronic hand tool with at least one button having an upper inclined surface which is an ergonomic structure so that the user can press the button comfortably and easily while the button will not be destroyed.

### BACKGROUND OF THE INVENTION

Electronic hand tools serve to display the tension applied to the hand tool so that the operator can drive an object with a precise force and has a well operation result. Thus the electronic hand tools are more and more popular in various working fields, such as being used in cars, motorcycles, airplanes, combustors, mechanic manufacturing, home electric devices, etc.

Buttons are installed on the electronic hand tool for the requirement in operations. Referring to FIGS. 1A to 1C, different forms of buttons used in the electronic hand tools are illustrated. In FIGS. 1A and 1C, each button has a flat upper surface which is not ergonomic because it is not suitable for the shape of the finger of user. Moreover, in pressing the button, the finger is possible in contact with an edge of the button so that the finger will feel uneasy. Furthermore, when the user's hand holds the handle of the tool, the handle will give a pressure to the buttons so that the buttons will actuate related functions, even the setting values are changed.

Referring to FIG. 1B, all the buttons have a round shape. However in operation the finger can not completely adhere upon the finger. Furthermore, as the hand of the user hold the handle of the tool, the round button causes that the button is easily pressed so as to induce some fault operations.

### SUMMARY OF THE INVENTION

Accordingly, the primary object of the present invention is to provide an electronic hand tool with at least one button having an upper inclined surface which is an ergonomic structure so that the user can press the button comfortably and easily while the button will not be destroyed.

To achieve above objects, the present invention provides an electronic hand tool comprises a handle installed with an electronic device for deriving a tension of the tool as the tool is used to drive an object and displaying the derived tension value; the handle being installed with an operating portion; the operating portion including a button which slightly protrudes from a surface of the handle; and an upper surface of the button being an inclined surface. The button has at least one function of controlling actuating the electronic device, calibration of the tension value, and adjusting the range of the tension, and determining the displaying unit of the tension value. The inclined surface is a cambered concave surface. One end of the driving portion is a ratchet head and another end of the driving portion is an opened end; and the ratchet head and opened end are installed at two ends of the handle.

The various objects and advantages of the present invention will be more readily understood from the following detailed description when read in conjunction with the appended drawing.

### BRIEF DESCRIPTION OF THE DRAWINGS

FIGS. 1A to 1C are schematic cross sectional views of the prior art electronic hand tools.

FIG. 2 is a perspective view of the electronic hand tool of the present invention.

FIG. 3A is a front cross sectional view of the electronic hand tool of the present invention.

FIG. 3B is a schematic view showing the operation of the button according to the present invention.

FIG. 4 is a schematic view showing the electronic hand tool of the present invention.

FIG. 5 shows various forms of the buttons of the present invention.

### DETAILED DESCRIPTION OF THE INVENTION

In order that those skilled in the art can further understand the present invention, a description will be provided in the following in details. However, these descriptions and the appended drawings are only used to cause those skilled in the art to understand the objects, features, and characteristics of the present invention, but not to be used to confine the scope and spirit of the present invention defined in the appended claims.

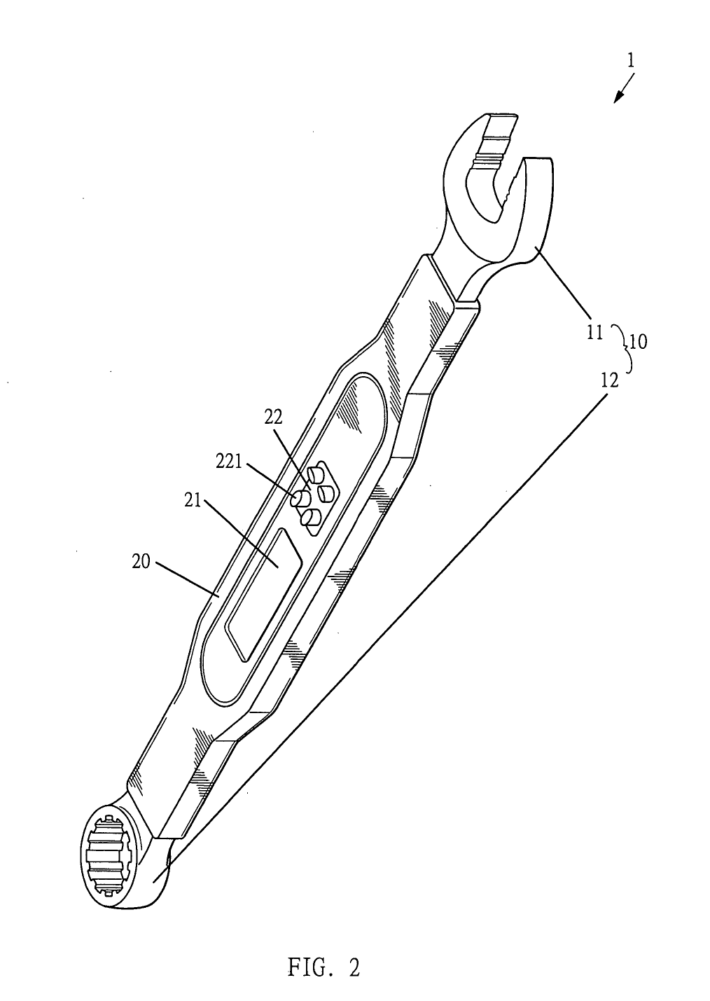

Referring to FIG. 2, the structure body 1 of the present invention is illustrated. The present invention has the following elements.

A handle 20 is installed with an electronic device 21 for deriving a tension of the body 1 as the body 1 is used to drive an object and displaying the derived tension value. The handle 20 is installed with an operating portion 22. The operating portion 22 includes four buttons 221 for controlling actuating the electronic device 21 (switching on and off), calibration of the tension value, and adjusting the range of the tension, and determining the displaying unit of the tension value.

A driving portion 10 is distributed at two ends of the handle 20. One end of the driving portion 10 is a ratchet head 12 and another end of the driving portion 10 is an opened end 11. The ratchet head 12 and opened end 11 are installed at two ends of the handle 20.

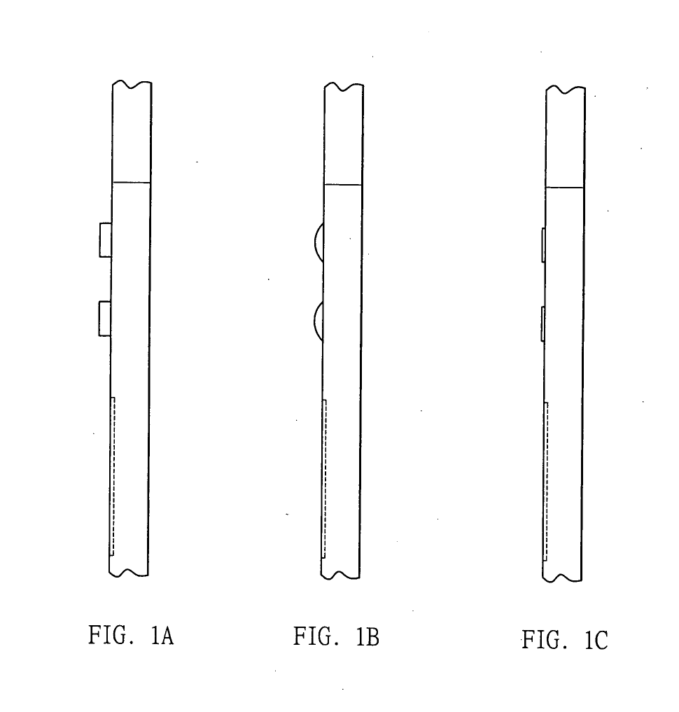

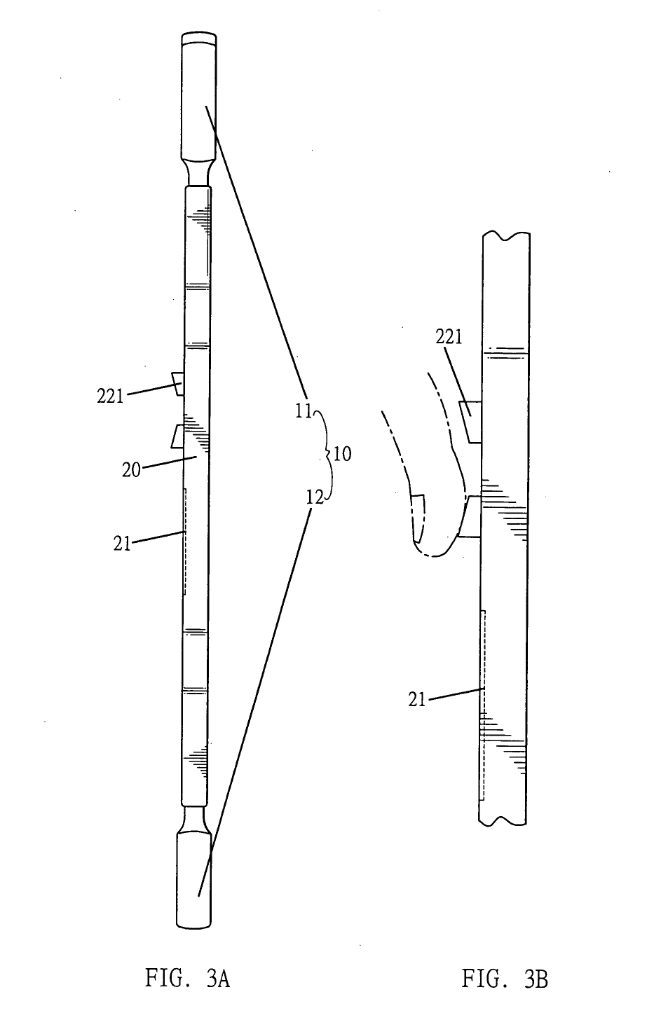

Referring to FIG. 3A, each button 221 protrudes from a surface of the handle 20. An upper side of each button 221 is formed as an inclined surface. The inclined surface has a shape corresponding to the curvature of a finger so that as the finger of the user contacts the button 221, the finger will feel easy and comfortable. Furthermore, even the finger is wet due to sweat, it will not slide from the button 221. Moreover, since the button 221 is only slightly protruded from the surface of the handle 20, it is only to slightly press the button 221 with a little force for driving the button 221 instead of using a great force to press the button 221 as those illustrated in FIG. 1C.

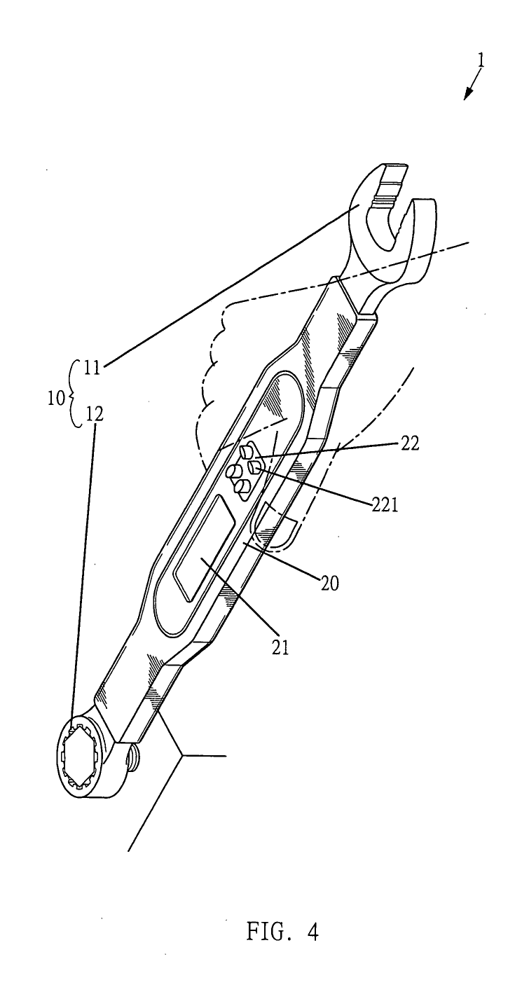

Referring to FIG. 4, in holding the handle 20, since the force to the button 221 will be dispersed and thus the button 221 will not collapse. Thus the setting in the electronic device 21 will not be changed by mistake in operation.

However in the present invention, the upper side of each button 221 may be formed as a concave cambered surface so that the finger can completely adhere to the upper surface of the button 221. In FIG. 2, the four buttons 221 are arranged as two parallel rows arranged along a longitudinal direction of the handle 20. Each row has two buttons 221. The surfaces of the two buttons 221 at the same rows face to one another.

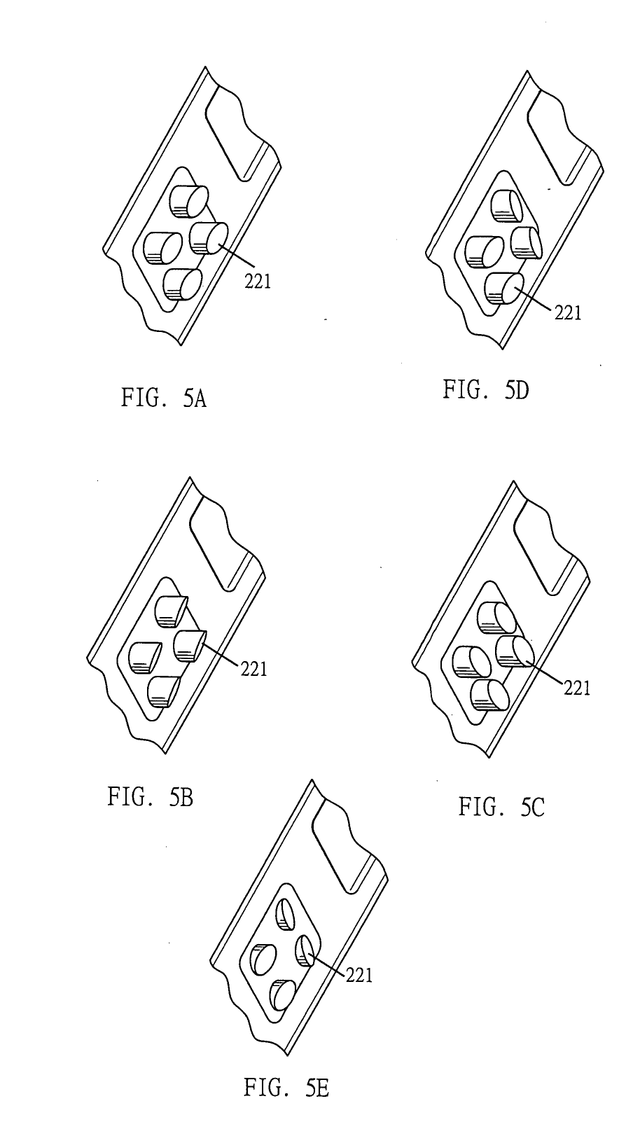

Referring to FIGS. 5A to 5E, in the present invention, the buttons 221 can be arranged in different form. In FIGS. 5A to 5E, the four buttons 221 are arranged as two parallel rows arranged along a longitudinal direction of the handle 20. In FIG. 5A, the inclined surfaces of all the buttons face to a same distal end of the handle 20. In FIGS. 5B and 5C, the inclined surfaces of all the buttons 221 face to a same direction which is the transversal direction of the handle 20. In FIG. 5D, the inclined surfaces of the two buttons 221 at the same row along the longitudinal direction of the handle 20 face to opposite directions. In FIG. 5E, the inclined surfaces of the two buttons 221 at the same row along the longitudinal direction of the handle 20 face to opposite directions and a lower side of each handle 20 is in contact to the surface of the handle 20.

The present invention is thus described, it will be obvious that the same may be varied in many ways. Such variations are not to be regarded as a departure from the spirit and scope of the present invention, and all such modifications as would be obvious to one skilled in the art are intended to be included within the scope of the following claims.

What is claimed is:

1. An electronic hand tool comprising:
a handle installed with an electronic device for deriving a tension of the tool as the tool is used to drive an object and displaying the derived tension value; the handle being installed with an operating portion; the operating portion including at least one button which slightly protrudes from a surface of the handle; and an upper surface of the button being an inclined surface.

2. The electronic hand tool as claimed in claim 1, wherein the button has at least one function of controlling the actuation of the electronic device, calibration of the tension value, and adjusting the range of the tension, and determining the displaying unit of the tension value.

3. The electronic hand tool as claimed in claim 1, wherein the inclined surface is a cambered concave surface.

4. The electronic hand tool as claimed in claim 1, wherein one end of the driving portion is a ratchet head and another end of the driving portion is an opened end; and the ratchet head and opened end are installed at two ends of the handle.

5. An electronic hand tool comprising:
a handle installed with an electronic device for deriving a tension of the tool as the tool is used to drive an object and displaying the derived tension value; the handle being installed with an operating portion; the operating portion including four buttons; each button protruding from a surface of the handle; an upper side of each button being formed as an inclined surface; and
a driving portion distributed at two ends of the handle.

6. The electronic hand tool as claimed in claim 5, wherein one end of the driving portion is a ratchet head and another end of the driving portion is an opened end; the ratchet head and opened end are installed at two ends of the handle.

7. The electronic hand tool as claimed in claim 5, wherein an upper side of each button is formed as a concave cambered surface.

8. The electronic hand tool as claimed in claim 5, wherein the four buttons are arranged as two parallel rows arranged along a longitudinal direction of the handle and each row has two buttons.

9. The electronic hand tool as claimed in claim 8, wherein the surfaces of the two buttons at the same rows face to one another.

10. The electronic hand tool as claimed in claim 8, wherein the inclined surfaces of all the buttons face to a same distal end of the handle.

11. The electronic hand tool as claimed in claim 8, wherein the inclined surfaces of all the buttons face to a same direction which is the transversal direction of the handle.

12. The electronic hand tool as claimed in claim 8, wherein the inclined surfaces of the two buttons at the same row along the longitudinal direction of the handle face to opposite directions.

13. The electronic hand tool as claimed in claim 8, wherein the inclined surfaces of the two buttons at the same row along the longitudinal direction of the handle face to opposite directions and a lower side of each handle is in contact to the surface of the handle.
